(19) United States
(12) Patent Application Publication
(10) Pub. No.: US 2011/0164379 A1
(43) Pub. Date: Jul. 7, 2011

(54) FASTENER FOR SECURING COMPUTER STORAGE DEVICE

(75) Inventors: WEI-CHEN WANG, TAIPEI HSIEN (TW); YU-JEN LI, TAIPEI HSIEN (TW); HSING-WANG CHAN, TAIPEI HSIEN (TW)

(73) Assignee: WISTRON CORPORATION, TAIPEI HSIEN (TW)

(21) Appl. No.: 12/832,482

(22) Filed: Jul. 8, 2010

(30) Foreign Application Priority Data
Jan. 5, 2010 (TW) 099100124

(51) Int. Cl. G06F 1/16

(52) U.S. Cl. 361/679.58

(57) ABSTRACT

A fastener for securing computer storage device is revealed. The fastener is arranged at a housing of computers and is hooked with a sliding member of a storage device so as to secure the storage device. The fastener includes a rotating shaft, a rotating fastening member arranged above the rotating shaft, an elastic element whose two ends are respectively arranged at the housing and the rotating fastening member, and a hook member disposed on the sliding member and hooked with the rotating fastening member. By the rotating fastening member and the hook member hooked with each other, the storage device is secured in the housing automatically and the convenience of assembling is enhanced. Moreover, an action force of the rotating fastening member on the hook member hooked is increased by the elastic member so as to reduce the releasing of the hooked rotating fastening member from the hook member.

### BACKGROUND OF THE INVENTION

1. Fields of the Invention

The present invention relates to a fastener, especially to a fastener for securing computer storage devices.

2. Descriptions of Related Art

A computer is an essential equipment for processing information. Computer hardware consists of a plurality of components such as a motherboard, various interface cards, a plurality of storage devices, and so on. The storage devices include floppy disks, hard disks, optical disk drives magnetic disk drives, etc. All components are disposed inside a housing of computers.

Take a laptop as an example, under the condition that there is no damage, disassembling and replacement of internal components of the laptop is not so often. However, if the file system is changed or the storage space is insufficient, the storage devices are moved or replaced more frequent. Compared with other components, the storage devices have higher replacement frequency. Due to compact design of the laptop, frequent replacement of the storage devices is not a proper measure. Thus the disposition of the storage device is by a removable structure that allows a disconnection of the storage device. The storage device can be replaced without disassembling of a laptop housing. Although the convenience of replacing the storage device is enhanced, the storage device is not securely mounted in the laptop sometimes. Once the removable storage device is not set up in the laptop properly and user turn on the computer under such condition, the storage device may be damaged.

The most common way to arrange the storage device in the laptop is by a holder used to receive a storage device. After the holder being set into a receiving slot for the storage device on side surfaces of a computer, screws are threaded from the back of the computer so as to fix the holder. A cover plate for covering the receiving slot is threaded onto the computer at last and the hard disk replacement is finished. The storage device assembled by this way has a shortcoming of time-consuming on the production line. This is also inconvenient for users to replace the storage device. And users may lose screws during the replacement process, even cause improper assembling of the storage device and further result in loosening and damages of the storage device. This assembling way causes users inconvenience although the storage device is fastened tightly. Thus there is a need to provide a simple way of assembling the storage device that also increases convenience of disassembling the storage device and enhance convenience of a laptop in use. A fastener for securing computer storage devices of the present invention increases convenience of assembling the storage device, prevent releasing of the storage device caused by improper assembly and enhance convenience of disassembly the storage device so as to solve problems mentioned above.

### SUMMARY OF THE INVENTION

Therefore it is a primary object of the present invention to provide a fastener for securing computer storage devices in which a housing is disposed with a rotating fastening member and a sliding member is arranged with a hook member. When the sliding member is mounted in the housing, the rotating fastening member and the hook member are automatically hooked with each other. Thus a storage device disposed on the sliding member is automatically secured in the housing during the assembly process. The convenience of assembling the storage device is increased by the hooking of the rotating fastening member with the hook member.

It is another object of the present invention to provide a fastener for securing computer storage devices in which one end of an elastic element is disposed on the housing while the other end thereof is arranged at the rotating fastening member. By the elastic element, an action force of the rotating fastening member on the hook member hooked is increased so that the releasing of the hooked rotating fastening member from the hook member caused by external forces can be prevented.

It is a further object of the present invention to provide a fastener for securing computer storage devices in which a rotating shaft is inserted from a bottom of the housing and a sealing member is disposed between the rotating shaft and the housing. The ingress of moisture or foreign objects into the housing that affects normal operation of computers can be minimized.

It is a further object of the present invention to provide a fastener for securing computer storage devices in which a rotating part is disposed on the bottom of the rotating shaft. Users can use tolls to rotate the rotating shaft for driving the rotating fastening member and the hook member releasing from each other easily by the rotating part. Thus the convenience of disassembling the storage device is enhanced.

In order to achieve objects, a fastener for securing computer storage devices according to the present invention is disposed on a housing of computers and is hooked with a sliding member. The sliding member is arranged with a storage device. The fastener for securing computer storage devices consists of a rotating shaft, a rotating fastening member, an elastic element and a hook member. The rotating shaft is arranged at the housing and the rotating fastening member is disposed above the rotating shaft. As to the elastic element, one end is set on the housing while the other end is disposed on the rotating fastening member. The hook member is arranged on the sliding member and is hooked with the rotating fastening member. By the rotating fastening member and the hook member hooked with each other, the storage device is automatically secured in the housing and the convenience of assembling the storage device is increased. Moreover, an action force of the rotating fastening member on the hook member hooked is increased by the elastic member so as to minimize the releasing of the hooked rotating fastening member from the hook member caused by external forces.

Furthermore, the housing is arranged with an axial hole and the rotating shaft is arranged in the axial hole that is located on the bottom of the housing. A sealing member is disposed between the rotating shaft and the housing so as to reduce the ingress of moisture or foreign objects that have effects on the normal operation of the computer.

In addition, a rotating part is arranged at the bottom of the rotating shaft so that uses can rotate the rotating shaft for releasing the rotating fastening member and the hook member from each other easily by tools. The convenience of disassembling the storage device is enhanced.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1A is a partial top view of a housing of computers of an embodiment according to the present invention;

FIG. 1B is a partial bottom view of housing of computers of an embodiment according to the present invention;

FIG. 1C is a schematic drawing showing disposition of a sliding member of an embodiment on a housing according to the present invention;

FIG. 1D is a partial enlarged view of the embodiment in FIG. 1B;

FIG. 2A is a perspective view of an embodiment of a fastener for securing computer storage devices according to the present invention;

FIG. 2B is an explosive view of an embodiment of a fastener for securing computer storage devices according to the present invention;

FIG. 3 is a perspective view of an embodiment of a fastener for securing computer storage devices from another angle of view according to the present invention;

FIG. 4 is a schematic drawing showing a bottom of a rotating shaft of an embodiment according to the present invention;

FIG. 5A to FIG. 5D are schematic drawings showing how an embodiment of a fastener for securing computer storage devices is hooked with a sliding member according to the present invention;

FIG. 6A is a perspective view of an embodiment of a fastener for securing computer storage devices according to the present invention;

FIG. 6B is an explosive view of an embodiment of a fastener for securing computer storage devices according to the present invention;

FIG. 6C is a schematic drawing showing an embodiment of a fastener for securing computer storage devices of the present invention assembled on a housing of computers.

### DETAILED DESCRIPTION OF THE PREFERRED EMBODIMENT

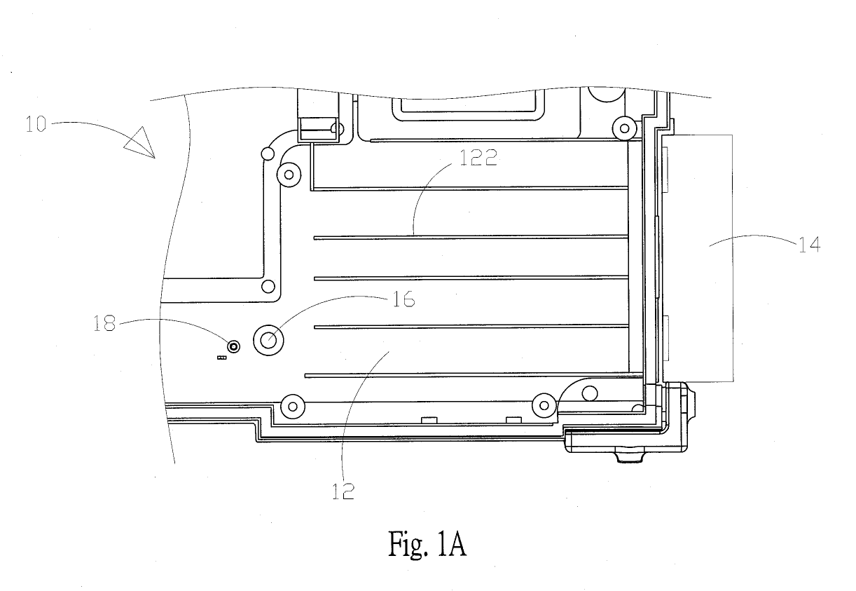

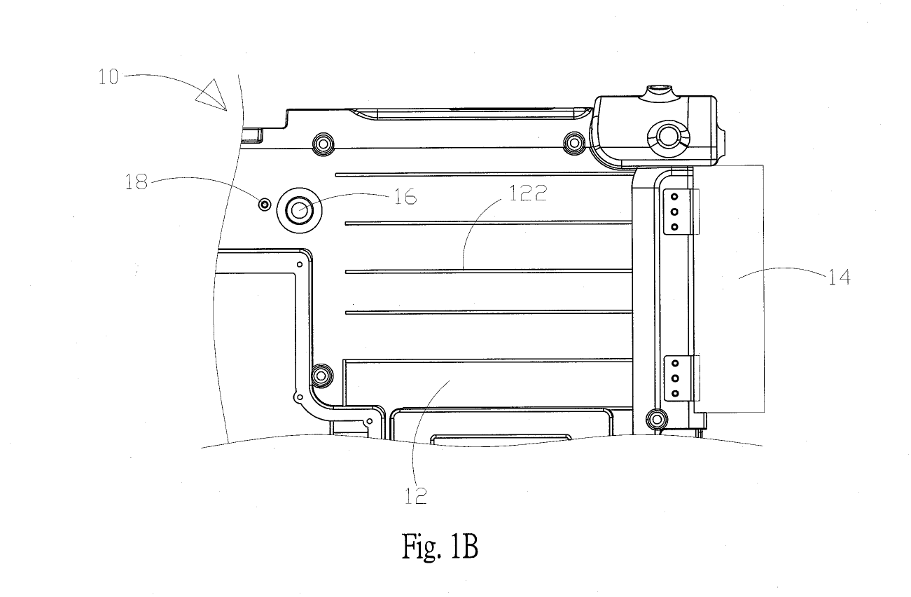

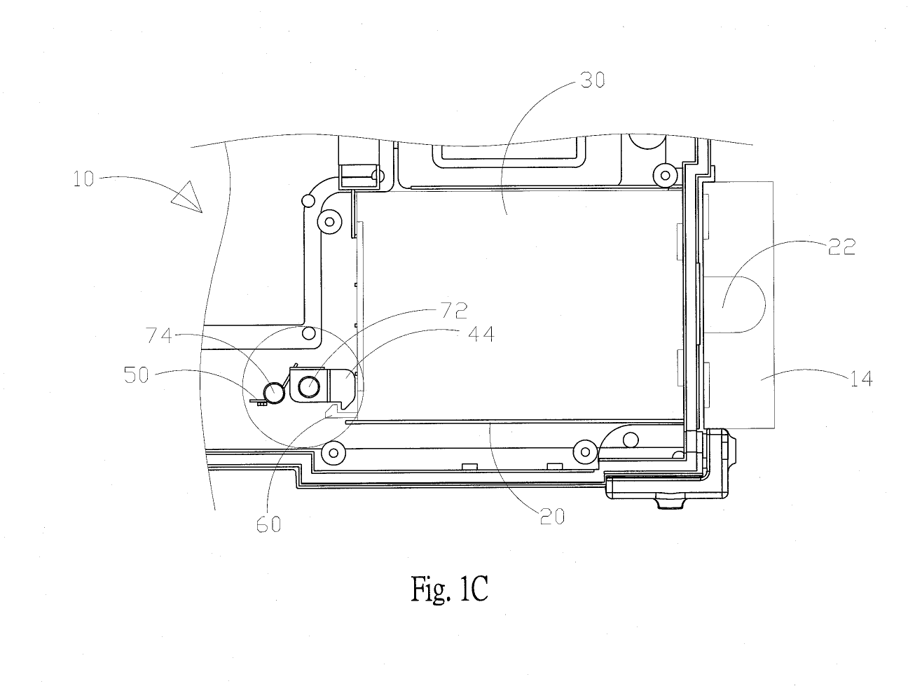

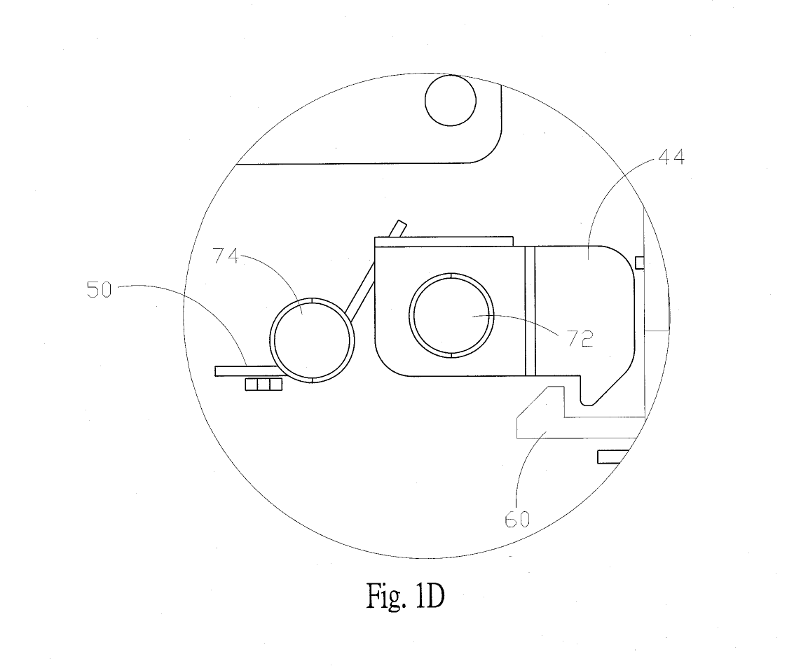

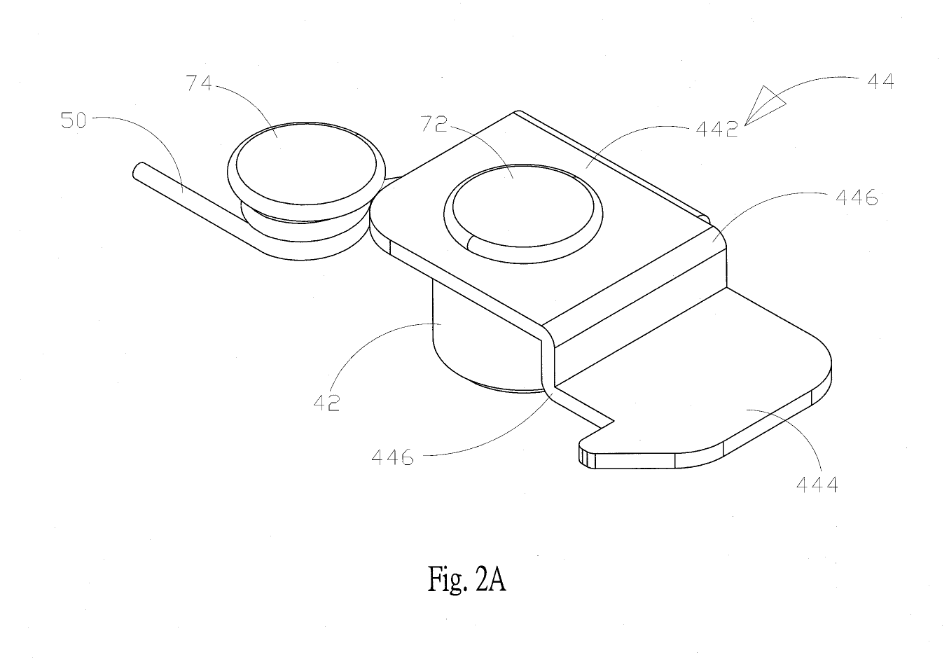

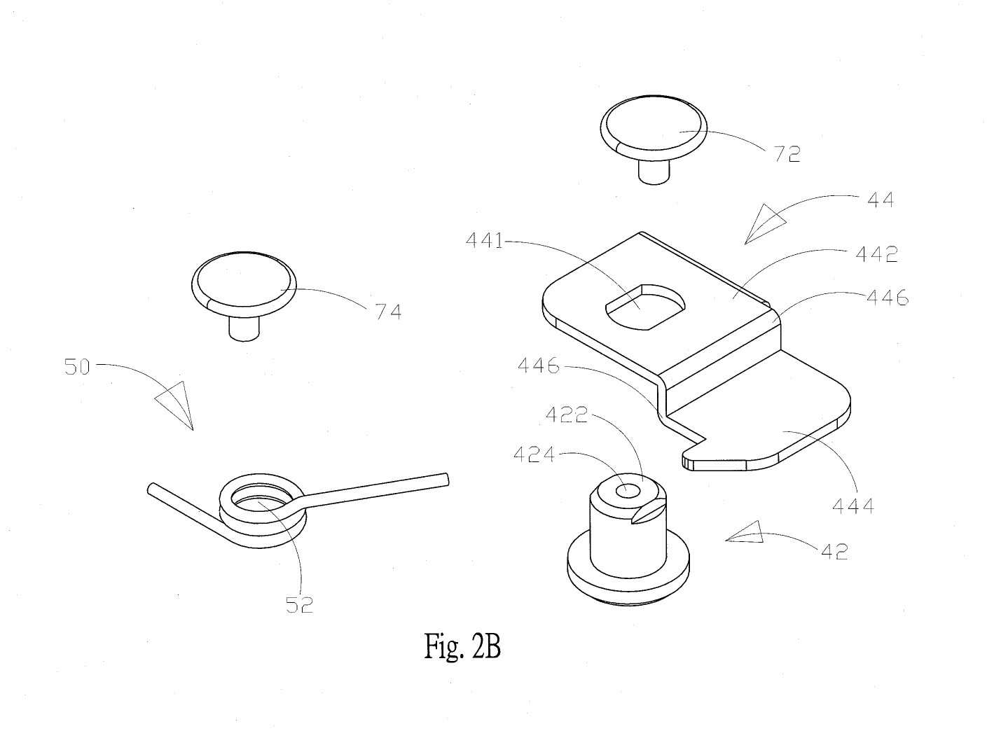

Refer from FIG. 1A to FIG. 2B, a fastener for securing computer storage devices according to the present invention is disposed on a housing 10 of computers. The fastener is hooked with a sliding member 20 that is disposed with a storage device 30 so as to secure the storage device 30. The fastener includes a rotating shaft 42, a rotating fastening member 44, an elastic element 50 and a hook member 60. The rotating shaft 42 is arranged at the housing 10 and the rotating fastening member 44 is disposed over the rotating shaft 42. One end of the elastic element 50 is set on the housing and the other end thereof is disposed on the rotating fastening member 44. The hook member 60 is installed on the sliding member 20 and is hooked with the rotating fastening member 44.

The housing 10 is arranged with a receiving slot 12 and a side cover 14 is disposed on one side of the receiving slot 12. While assembling the sliding member 20, the side cover 14 is opened and the sliding member 20 is mounted and sliding in the receiving slot 12. For convenience of sliding in the receiving slot 12, the receiving slot 12 includes a plurality of projective members 122 that reduces friction between the sliding member 20 and the housing 10. For easy assembling and disassembling of the sliding member 20, an anti-slip part 22 is disposed on the sliding member 20. The contact area between users and the sliding member 20 is increased by the anti-slip part 22 so as to increase the convenience to users taking the sliding member 20.

For easy arrangement of the rotating shaft 42 on the housing, the housing 10 is mounted with an axial hole 16, as shown in FIG. 1A and FIG. 1B. The rotating shaft 42 is inserted through the axial hole 16 from a bottom of the housing 10. Then the rotating fastening member 44 is fixed on the rotating shaft 42. In order to increase the assembling convenience of the rotating fastening member 44 with the rotating shaft 42, a fixing part 422 is set on top of the rotating shaft 42 while a fixing hole 441 is mounted on the rotating fastening member 44. The shape of the fixing hole 441 is corresponding to the shape of the fixing part 422. Thus while assembling the rotating fastening member 44 with the rotating shaft 42, the fixing hole 441 of the rotating fastening member 44 is inserted by the fixing part 422 of the rotating shaft 42 and the rotating fastening member 44 is fixed on the rotating shaft 42 firmly due to corresponding shapes of the fixing hole 441 and the fixing part 422. Thus the rotating fastening member 44 can be rotated after the rotating shaft 42 being assembled with the axial hole 16.

The rotating fastening member 44 is composed of a connection part 442 and a locking part 444, as shown in FIG. 2A. The connection part 442 is disposed on the rotating shaft 42 while the locking part 444 is connected with the connection part 442 and is hooked with the hook member 60. Moreover, the rotating fastening member 44 further includes a plurality of bending parts 446 located between the connection part 442 and the locking part 444. In this embodiment, there are two bending parts 446. The disposition of the bending parts 446 is to make the locking part 444 attach to the housing 10 securely while the locking part 444 being connected with the connection part 442. Thus the locking part 444 and the hook member 60 are on the same plane while locking with each other. Therefore the locking of the rotating fastening member 44 with the hook member 60 becomes more convenient.

For the convenience of assembling the rotating shaft 42, the present invention further includes a first fastening member 72 and a second fastening member 74. The first fastening member 72 is used to fix the rotating fastening member 44 on the rotating shaft 42 while the second fastening member 74 is to arrange the elastic element 50 on the housing 10. The rotating shaft 42 is arranged with a first fastening hole 424 and the first fastening member 72 is inserted through the rotating fastening member 44 and is mounted into the first fastening hole 424. The housing 10 is mounted with a second fastening hole 18 and the second fastening member 74 penetrates the elastic element 50 to be mounted in the second fastening hole 18. For easily assembling of the elastic element 50 to the housing 10, the elastic element 50 includes an insertion hole 52. In this embodiment, the elastic element 50 is a spring whose center is an insertion hole 52 formed by a wound metal part. The second fastening member 74 is inserted into the insertion hole 52 so as to dispose the elastic element 50 on the housing. Moreover, the elastic element 50 is rotated around the insertion hole 52 in a small range.

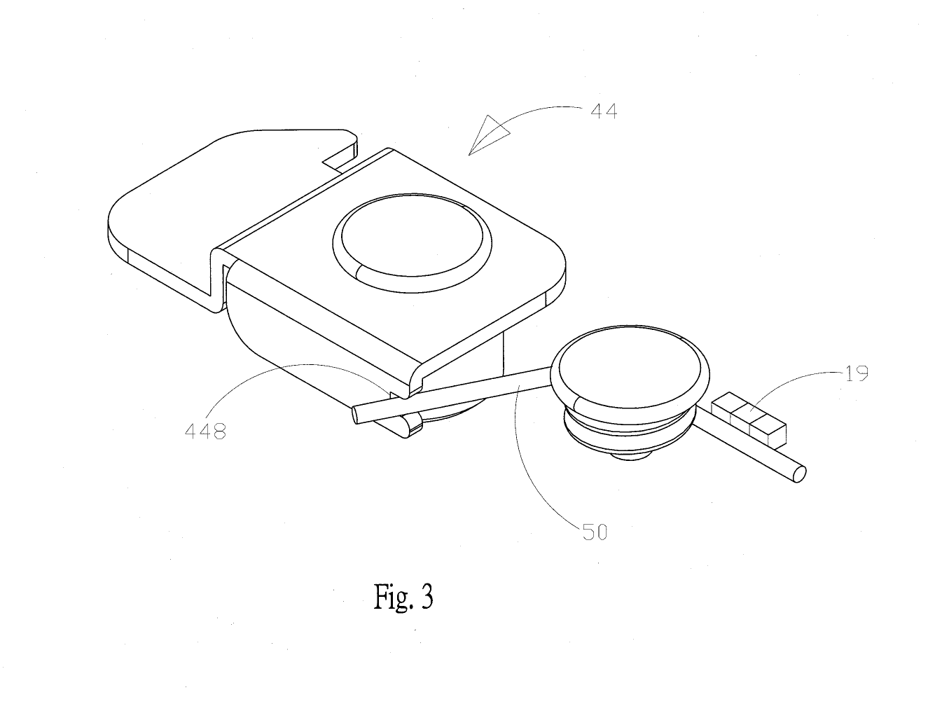

Refer to FIG. 3, a perspective view from another angle of view of an embodiment according to the present invention is revealed. As shown in figure, in order to make the elastic element 50 become more effective, one end of the elastic element 50 is fixed on the housing 10 while the other end thereof is fixed on the rotating fastening member 44. For convenient fixing of the elastic element 50, a stopper 19 is disposed on the housing 10 and one end of the elastic element 50 rests against the stopper 19 while a slot 448 is set on one side of the rotating fastening member 44 and the other end of the elastic element 50 is mounted in the slot 448. Thus after rotation, the rotating fastening member 44 can turn back to original position due to elasticity from the elastic element 50. Therefore, when the sliding member 20 is set inside the housing 10, the rotating fastening member 44 and the hook member 60 are hooked with each other automatically so as to fasten the storage device 30 in the housing 10 and the convenience of assembling the storage device 30 is improved. Moreover, an action force of the rotating fastening member 44 on the hook member 60 is increased by the elastic element 50 so as to prevent the hooked rotating fastening member 44 and the hook member 60 from releasing from each other caused by external forces.

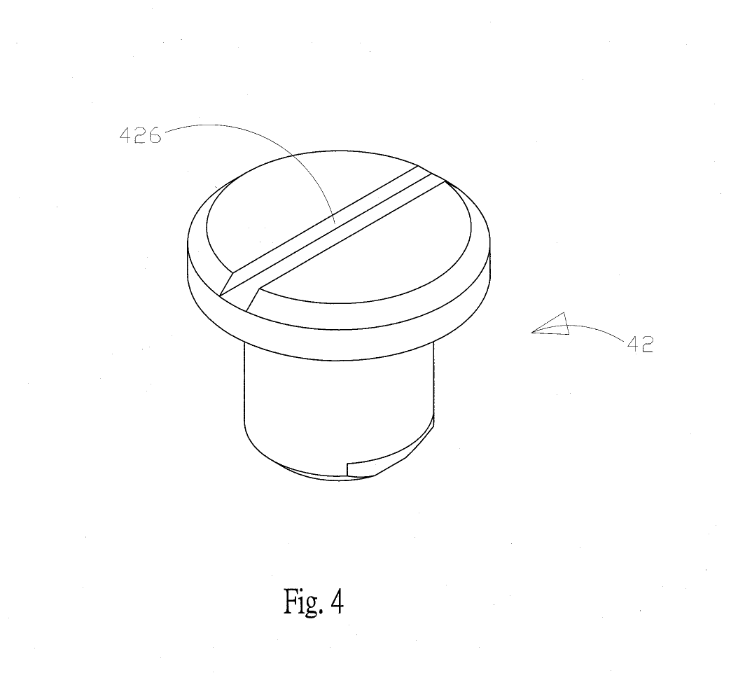

Refer to FIG. 4, a schematic drawing of the rotating shaft 42 shows a bottom of the rotating shaft 42. For disassembling of the sliding member 20, the rotating fastening member 44 must be rotated so as to be released from the hook member 60. In order to rotate the rotating fastening member 44, the rotating shaft 42 is to be rotated for driving the rotating fastening member 44. For user's convenience of rotating the rotating shaft 42, a rotating part 426 is disposed on the bottom of the rotating shaft 42. In this embodiment, the rotating part 426 is a linear (hook) slot. Thus users can use a linear fastening tool to rotate the rotating shaft 42. Thus the convenience of disassembling the storage device 30 is enhanced. In other embodiments, hook slots or slots with different shapes can be mounted on the rotating shaft 42 and a fastening tool corresponding to the shape of the hook slots or slots is used to rotate the rotating shaft 42.

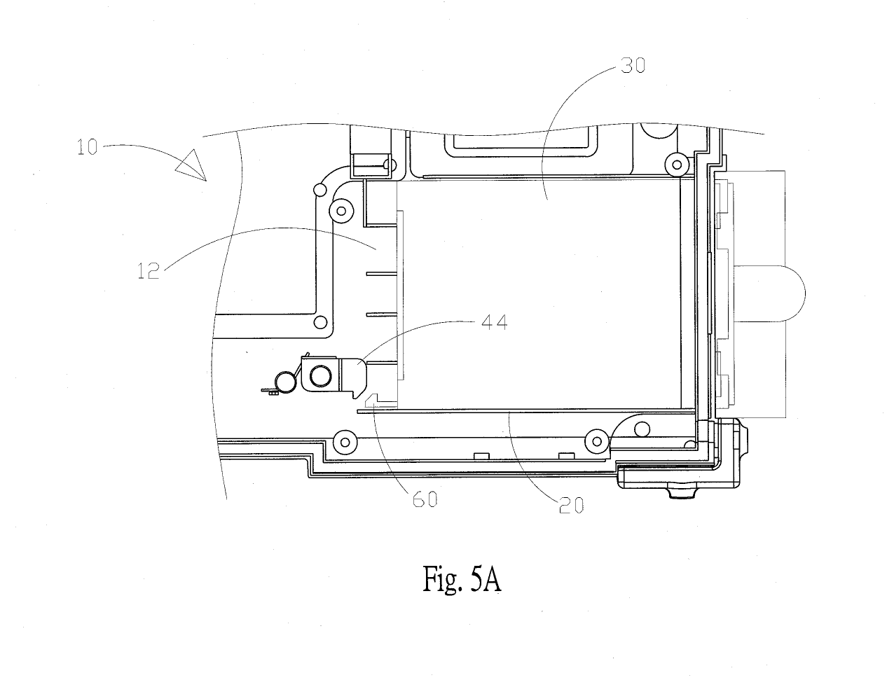

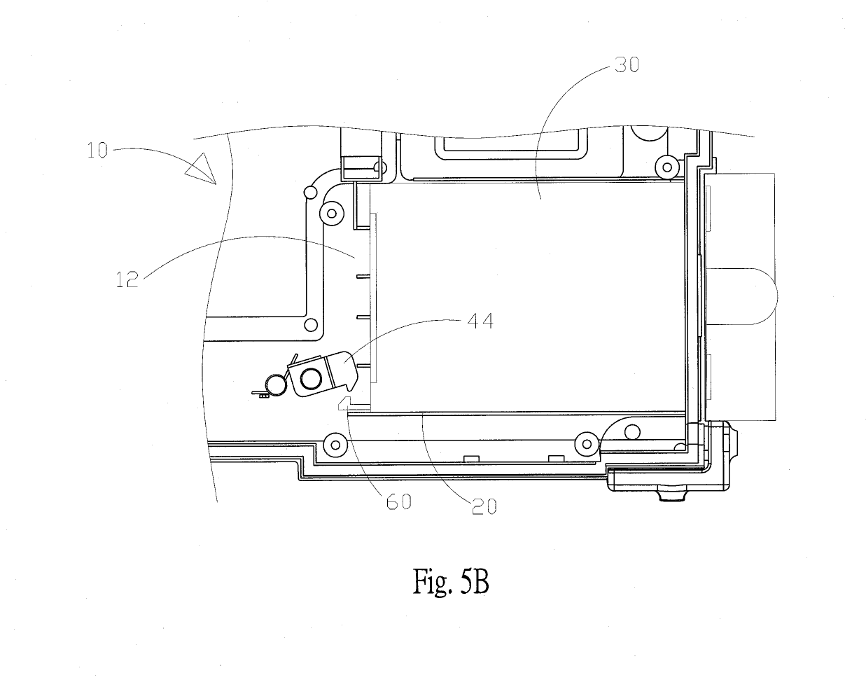

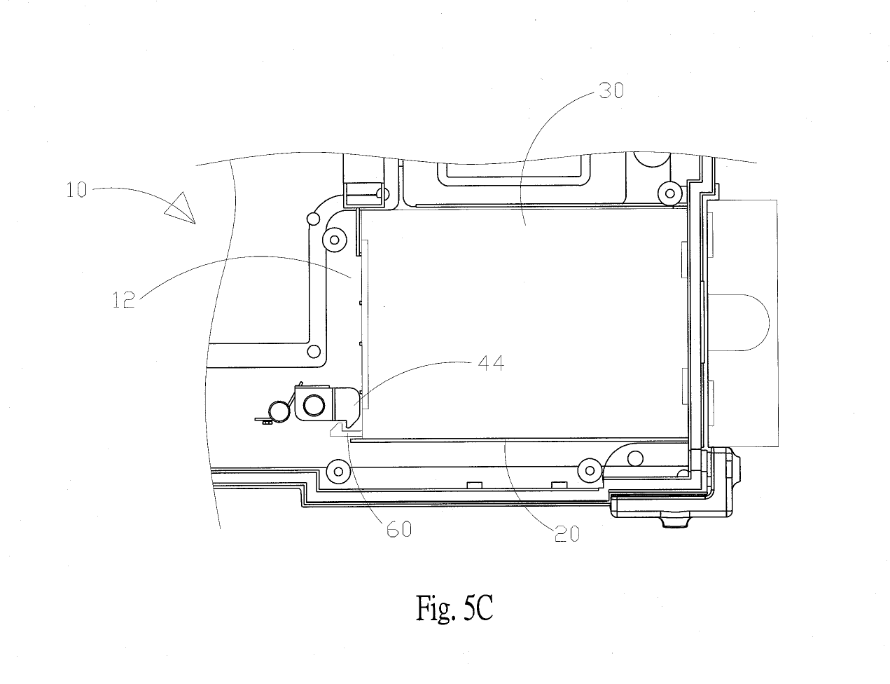

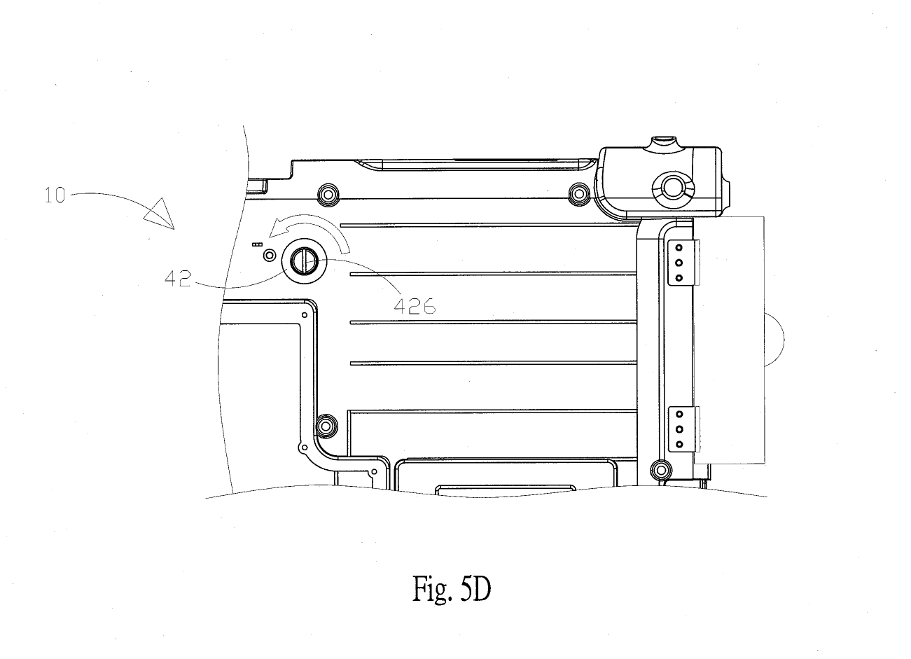

Refer from FIG. 5A to FIG. 5D, these are schematic drawings showing how an embodiment of the present invention is hooked with the sliding member. When users intend to assemble the sliding member 20 on the computer housing 10, firstly open the side cover 14, as shown in FIG. 5A, slide the sliding member 20 with the storage device 30 into the receiving slot 12 so that the hook member 60 is getting closer to the rotating fastening member 44. Then refer to FIG. 5B, push the sliding member 20 inwards so as to make the hook member 60 and the rotating fastening member 44 push each other and the rotating fastening member 44 rotates in a small circle. Next as shown in FIG. 5C, continue pushing the sliding member 20 moving into an inner side of the receiving slot 12 and the rotating fastening member 44 turns back to original position. Thus the rotating fastening member 44 and the hook member 60 are locked with each other so as to fasten the storage device 30 inside the housing 10 of computers.

While disassembling the storage device 30, refer to FIG. 5D, insert a linear tool into the rotating part 426 of the rotating shaft 42 and rotate the tool to drive the rotating shaft 42 to rotate. Refer to FIG. 5B, now the rotating shaft 42 drives the rotating fastening member 44 to be released from the hook member 60. Thus the sliding member 20 is pulled out of the receiving slot 12.

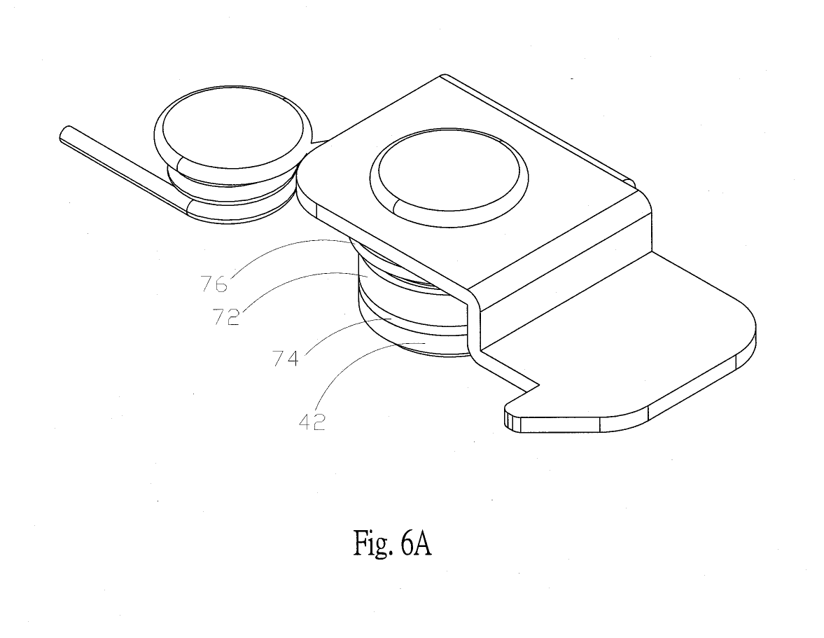

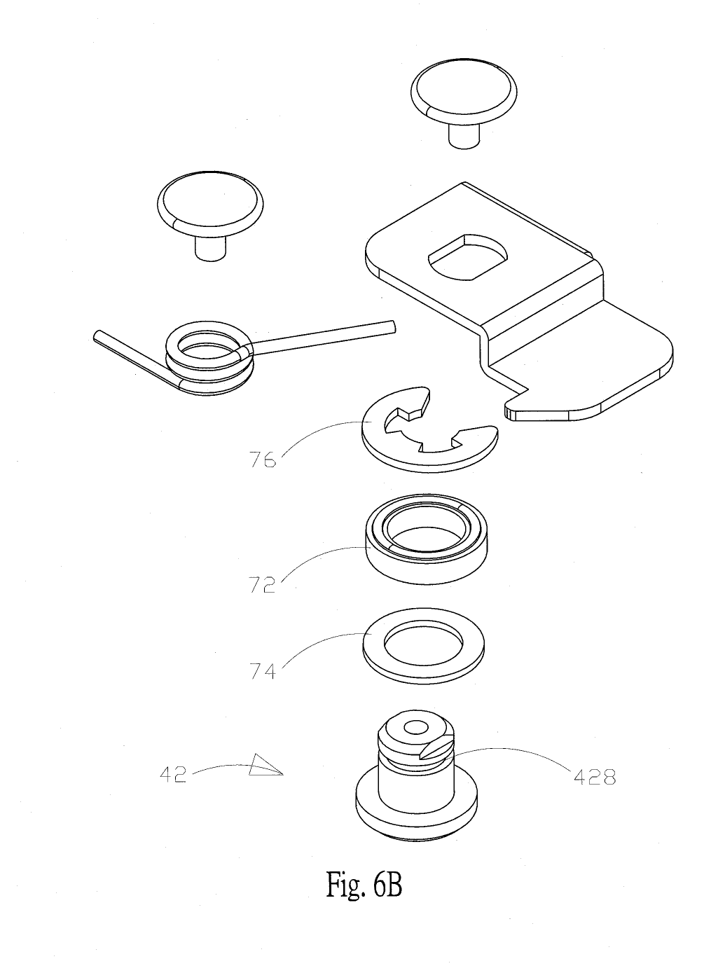

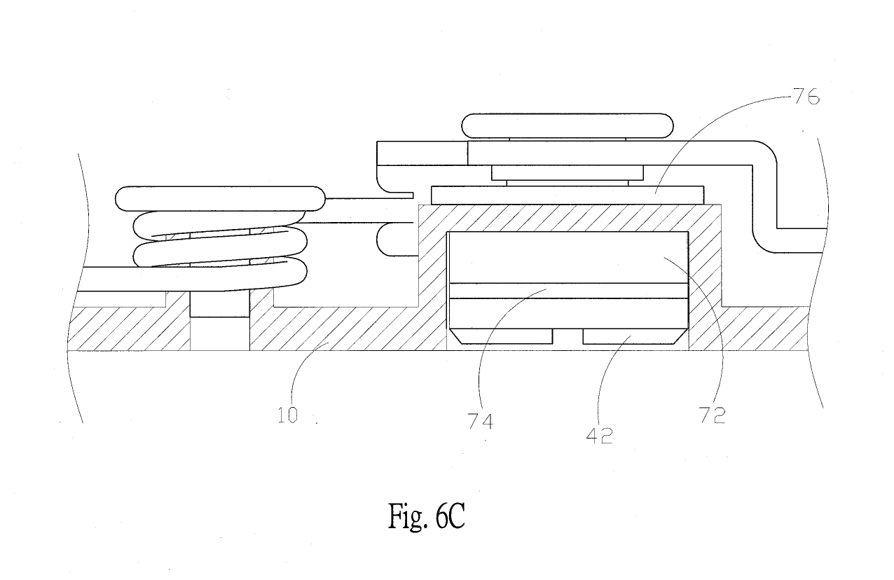

Refer from FIG. 6A, FIG. 6B, to FIG. 6C, in order to prevent ingress of moisture or foreign objects, from into a connection between the rotating shaft 42 the housing 10, the present invention further includes a sealing member 72 that is arranged between the rotating shaft 42 and the housing 10. The sealing member 72 is made from an elastic material such as rubber. When the rotating shaft 42 is disposed on the housing 10, the rotating shaft 42 presses the sealing member 72. The connection between the rotating shaft 42 the housing 10 becomes more closely due to the arrangement of sealing member 72. Thus the entry of moisture and foreign objects into the computer that affects the normal operation of computers can be minimized.

Furthermore, in addition, the embodiment further includes a washer 74. The sealing member 72 is made from elastic material so that friction between the rotating shaft 42 and the housing 10 is increased when the sealing member 72 is disposed between the rotating shaft 42 and the housing 10. Thus for maintaining both tightness between the rotating shaft 42 and the housing 10 as well as normal rotation of the rotating shaft 42, the washer 74 is installed between the sealing member 72 and the rotating shaft 42. Therefore, the rotating shaft 42 can rotate smoothly.

In addition, in order to prevent the rotating shaft 42 from falling off the housing that affects the use of the storage device, the embodiment further includes a stop member 76 while the rotating shaft 42 is disposed with a stop slot 428 and the stop member 76 is corresponding and mounted to the stop slot 428. Moreover, the stop member 76 is disposed over the axial hole 16. Thus when the stop member 76 is arranged on the rotating shaft 42, the rotating shaft 42 can rotate in a certain range on the housing 10.

In summary, a fastener for securing computer storage devices according to the present invention is disposed on a housing of computers and is hooked with a sliding member. The fastener for securing computer storage devices consists of a rotating shaft disposed on the housing, and a rotating fastening member arranged at the rotating shaft while the sliding member is set with a hook member. When the sliding member is mounted in the housing, the hook member of the sliding member is hooked with the rotating fastening member. By the hooking of the rotating fastening member with the hook member, the storage device mounted on the sliding member is automatically secured in the housing and the convenience of assembling the storage device is enhanced.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A fastener for securing computer storage devices disposed on a housing of computers and hooked with a sliding member on a storage device for fastening the storage device comprising:
a rotating shaft disposed on the housing,
a rotating fastening member arranged above the rotating shaft,
an elastic element whose one end is disposed on the housing while the other end is arranged at the rotating fastening member, and
a hook member disposed on the sliding member and hooked with the rotating fastening member.

2. The device as claimed in claim 1, wherein the housing is arranged with an axial hole and the rotating shaft is mounted in the axial hole and is located under the housing.

3. The device as claimed in claim 2, wherein the fastener for securing computer storage devices further includes a sealing member disposed between the rotating shaft and the housing.

4. The device as claimed in claim 3, wherein the fastener for securing computer storage devices further includes a washer arranged between the sealing member and the rotating shaft.

5. The device as claimed in claim 2, wherein the fastener for securing computer storage devices further includes a stop member while the rotating shaft is disposed with a stop slot and the stop member is mounted to the stop slot and is located over the axial hole.

6. The device as claimed in claim 1, wherein a fixing part is set on the rotating shaft while a fixing hole is mounted on the rotating fastening member and the fixing part is inserted through the fixing hole.

7. The device as claimed in claim 6, wherein the fixing part and the fixing hole have corresponding shapes.

8. The device as claimed in claim 1, wherein the fastener for securing computer storage devices further includes a first fastening member and the rotating shaft is arranged with a first fastening hole; the first fastening member is inserted through the rotating fastening member and is mounted into the first fastening hole.

9. The device as claimed in claim 1, wherein the fastener for securing computer storage devices further includes a second fastening member and the housing is mounted with a second fastening hole; the second fastening member penetrates the elastic element to be mounted into the second fastening hole.

10. The device as claimed in claim 9, wherein the elastic element is disposed with an insertion hole and the second fastening member is inserted through the insertion hole.

11. The device as claimed in claim 1, wherein the housing is arranged with a stopper and one end of the elastic element is against the stopper.

12. The device as claimed in claim 1, wherein a slot is set on one side of the rotating fastening member and the other end of the elastic element is mounted in the slot.

13. The device as claimed in claim 1, wherein the rotating fastening member includes:
a connection part disposed on the rotating shaft; and
a locking part that is connected with the connection part and is hooked with the hook member.

14. The device as claimed in claim 13, wherein the rotating fastening member further includes a plurality of bending parts located between the connection part and the locking part.

15. The device as claimed in claim 1, wherein the housing is disposed with a receiving slot while the sliding member is mounted and sliding in the receiving slot.

16. The device as claimed in claim 15, wherein a plurality of projective members is arranged in the receiving slot.

17. The device as claimed in claim 15, wherein the housing is arranged with a side cover that is located on one side of the receiving slot.

18. The device as claimed in claim 15, wherein an anti-slip part is disposed on the sliding member.

19. The device as claimed in claim 1, wherein a rotating part is disposed on the bottom of the rotating shaft.
